(19) United States
(12) Patent Application Publication
(10) Pub. No.: US 2018/0107664 A1
(43) Pub. Date: Apr. 19, 2018

(54) System, Method and Apparatus for Data Management with Programmable Behaviors on Containers for Collections of Data

(71) Applicant: Charles Nicholls, Los Angeles, CA (US)

(72) Inventor: Charles Nicholls, Los Angeles, CA (US)

(21) Appl. No.: 15/297,593

(22) Filed: Oct. 19, 2016

(51) Int. Cl. G06F 17/30

(52) U.S. Cl. CPC G06F 17/3051; G06F 17/30386

(57) ABSTRACT

System, method and apparatus are provided for creating and managing programmable behaviors on containers for collections of data items presented through the operating environment. This invention comprises recognizing an event in a system, identifying if the event matches a trigger in the trigger table and retrieving the behavior associated with the matching trigger, and executing the behavior associated with the trigger. The event can occurs to a container or an object in a container, such as the addition of a new object to the container. The event can also be a system wide event. The executed behavior can initiate another event

### CROSS REFERENCE TO RELATED APPLICATIONS

None

### FIELD OF THE INVENTION

Embodiments of the invention generally relate to data processing systems and management of data. Specifically, embodiments of the invention relate to systems with programmable containers for collections of data.

### BACKGROUND OF THE INVENTION

Data processing systems, computers, networks of computers, or the like, offer users and programs various ways to organize and manage data via the operating system (“OS”). Data consists of a stored sequence of bits. A data object may include but is not limited to the contents of a file, a portion of a file, a data record, a page in memory, an object in an object-oriented program, a digital message or any other digital representation of information.

An OS on a computer generally provides a file system in which data items are organized and stored as files on a suitable storage medium. Files can be grouped into collections of files, known as directories, which can then be grouped into other directories. Users and programs must navigate through a hierarchical path of directories in order to find a particular data object (file). The OS provides for interaction with the file system via a “shell” or operating environment (“OE”) which can be controlled through a command line or its equivalent graphical user interface

In a database management system, data is organized as records in tables. These tables can be grouped into database files. Users and programs must query the database tables to find a particular data item (record) using a dedicated database application.

The existing data management structures provide little beyond organization and storage of data. Many decisions as to the organization and storage of data are made by the user in the manual creation of directories or by the OS with basic default directories (My Documents, My Pictures, etc.). Therefore, a need exists for the ability to create and manage containers and data using programmable behaviors.

### SUMMARY

System, method and apparatus are provided for creating and managing programmable behaviors on containers for collections of data items presented through the operating environment. This invention gives a container (folders or enhanced containers) the ability to be more than a straight-forward receptacle to contain a collection of data objects and other sub-containers. The present invention provides for enhanced programmable containers with code fragments that execute on various conditions. Once the trigger conditions are met, the program code evaluates and carries out the actions/behaviors specified by the user.

The invention comprises recognizing an event in a system, identifying if the event matches a trigger in the trigger table and retrieving the behavior associated with the matching trigger, and executing the behavior associated with the trigger. The event can occurs to a container or an object in a container, such as the addition of a new object to the container. The event can also be a system wide event. The executed behavior can initiate another event

### BRIEF DESCRIPTION OF THE DRAWINGS

The accompanying drawings taken in conjunction with the detailed description will assist in making the advantages and aspects of the disclosure more apparent.

FIG. 1 is a diagram of a container and its contents.

FIG. 2 is a flowchart of the activation of a behavior.

FIG. 3 is a flowchart of the activation of a behavior in response to an outside event.

FIG. 4 is a flowchart of the filing an object in a container according to rules and the corresponding activation of a behavior in response to the filing event.

FIG. 5 is a block diagram of a general system embodiment on a single computer.

FIG. 6 is a block diagram of an alternative system embodiment on a single computer.

FIG. 7 is a block diagram of a general system embodiment on multiple computers.

### DETAILED DESCRIPTION

Reference will now be made in detail to the present embodiments discussed herein, illustrated in the accompanying drawings. The embodiments are described below to explain the disclosed system, apparatus, and method by referring to the Figures using like numerals. It will be nevertheless be understood that no limitation of the scope is thereby intended, such alterations and further modifications in the illustrated device, and such further applications of the principles as illustrated therein being contemplated as would normally occur to one skilled in the art to which the embodiments relate.

The subject matter is presented in the general context of system and program modules that are able to read and write data to memory, physical storage, databases, or similar. Those skilled in the art will recognize that other implementations may be performed that may include different data structures, components, or routines that perform similar tasks. The invention can be practiced using various computer system configurations, such as client server systems. Other usable systems can include, but are not limited to, mainframe computers, microprocessors, personal computers, smart phones, tablets, and other consumer electronic devices. Such computer devices may include one or more processors, data storage in the form of memory (hard disk, random access memory, cache memory, etc.) or a database, and an OS.

System, method and apparatus are provided for creating and managing programmable behaviors on containers for collections of data items presented through the operating environment. The present invention provides for enhanced programmable containers with code fragments that execute on various conditions.

Data management systems have been developed with means to form groups of data items. For example, in a typical file system, users and programs can create collections of items in a file system by placing data files in directories and subdirectories. Data can also be organized using containers for making collections, giving users the ability to group files or other data objects according to their preference.

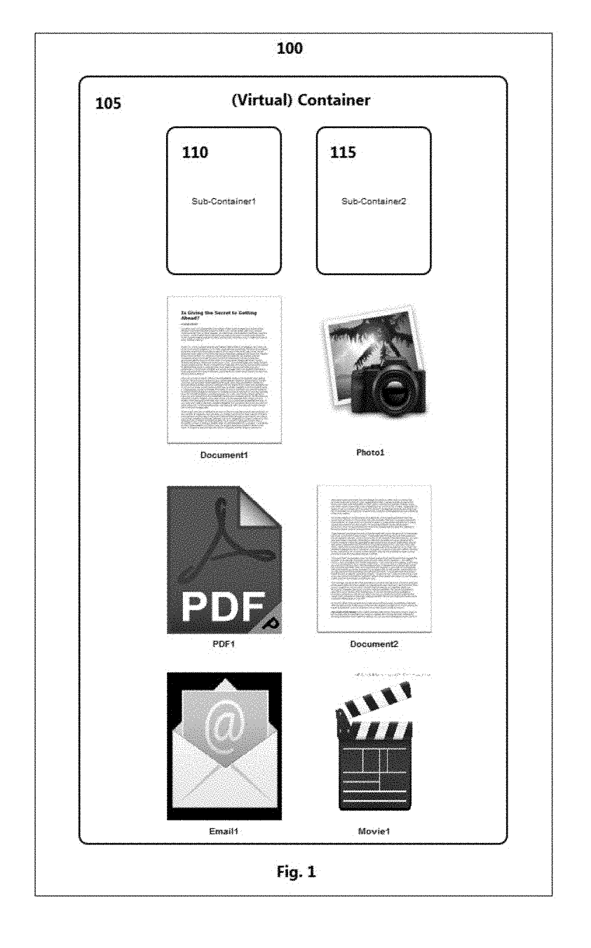

As illustrated in FIG. 1, a container 105 for a collection of data is provided. The contents of such a container may be heterogeneous as to data format and storage type, provided that a suitable method of presentation of such heterogeneous data to the container system is present. Containers may contain various forms of data such as documents (text files, PDFs, etc.), pictures, multimedia (audio, video, movie, etc.), emails, and database records (provided, of course, such emails or database records can be ingested into the system as independent documents). Additionally, containers can contain other containers 110, 115, referred to as child container or sub-containers which may also contain heterogeneous data. In a file system, these containers are commonly referred to as folders, directories, sub-folders or sub-directories. A user can browse through containers and sub-containers to view data.

Data is organized in containers called folders in an OS file system, where the user is able to manually organize data files. When saving documents created by document editors or downloading attachments from email applications, the file's location can be according to some default setting, or manually (users can browse through folder directories to select the location to place the data object), or a combination of both. Additionally, users can manually place data objects in folders using common file system commands such as cut, copy and paste.

An enhanced container system can provide virtual containers with the basic functionality of an OS file system. In an enhanced container system, document/data objects can be made to have more layers, properties and other attribute information than normal files in a file system. A data management application can present to the user a file management interface using enhanced containers.

This invention provides for the ability of containers (folders or enhanced containers) to be more than a straight-forward receptacle to contain a collection of data objects and other sub-containers. Embodiments depicted provide for containers to have triggers, attached to a container, that execute on various conditions. Once the trigger conditions are met, the code evaluates and carries out the programmed actions/behaviors specified by the user.

Triggers are conditions and code fragments which are actuated by events, which can include changes in the container or elsewhere. The system is configured to be constantly monitoring for events or changes in the system (disk read/writes, changes to file paths and attributes, system clocks, and other system events). These events can be a change in the membership of the container, such as the addition or removal of a data item from the container. It can also be a change in the data of a member of the container, such as a modification of the object's role, status, state, data or metadata. It can also result from an event external to the container, such as the occurrence of a date or time lapse. As part of analyzing events, the properties, metadata, or content of data objects can be examined by the system and used in identifying if the event matches a trigger.

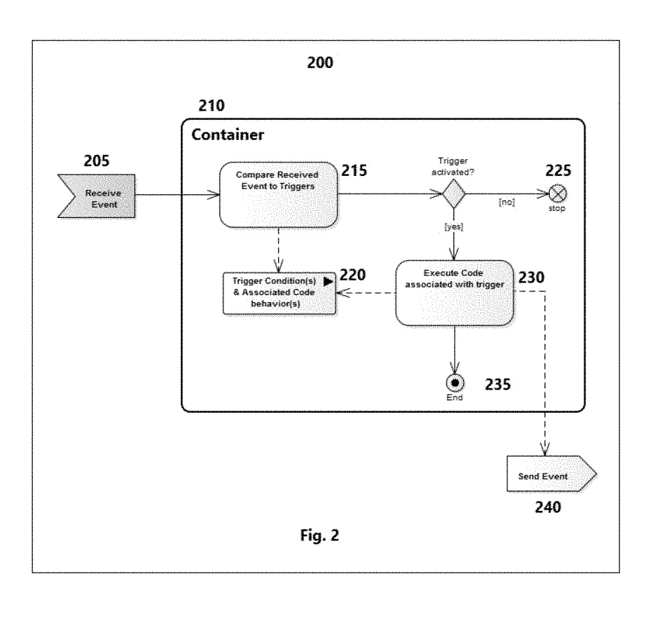

As illustrated in FIG. 2, a flowchart 200 of the activation of a behavior, is provided.

A new event 205 is receive by the container 210 in the system. The system queries 215 whether an event trigger exists in the trigger list or table 220. If no triggers are found, the process stops 225. If a trigger is activated then its associated code/behavior executes 230 and the process concludes 235. The associated code may include sending an additional event 240 to the system.

Events trigger a response in the form of a behavior/program code that is executed. Program code can take on various forms which can include, but are not limited to, system commands, executable object code, and scripts. Potential behaviors resulting from triggers could be to move data objects and/or modify the object's data content, metadata, state, status, permissions, and/or controls. The executed program code might for example prefix text to the data object's name to better identify the object. Or if the trigger acted on an email (provided, of course, such emails can be ingested into the system as independent documents), it might be activated by something in the subject line or text to respond automatically to the sender. For example, the system could create an email draft responding to an email that contains “ASAP” or other key words in the email subject or body.

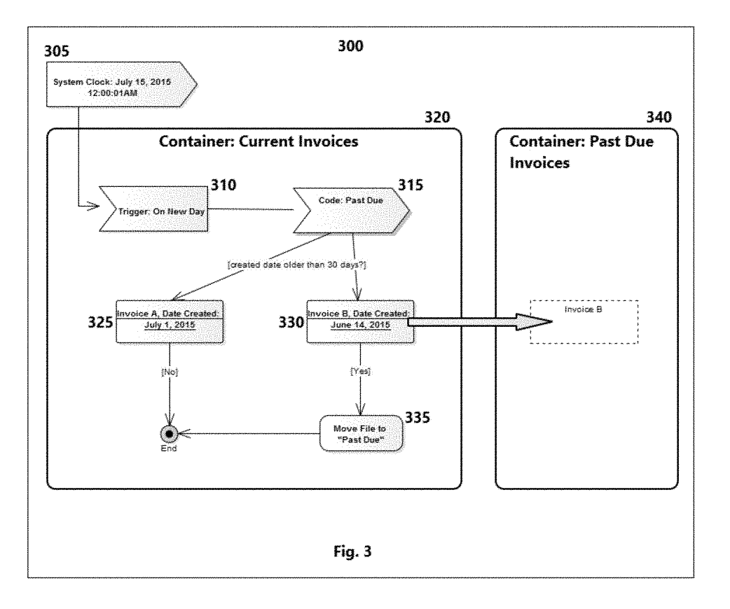

As illustrated in FIG. 3, a flowchart 300 of the activation of a behavior in response to an outside event is provided.

The trigger moves Invoices that are more than 30 days old from a folder indicating that they are current to a folder indicating that they are past due. An event occurs on the container system. As depicted, according to the system clock, it is now past midnight indicating the start of a new day, Jul. 15, 2015 305. This global system wide event is external to the container and can affect many containers and a large amount of data in the system. A trigger 310 in or associated with the container responds to the new day event 305. The trigger causes code 315 to be executed upon the beginning of a new day. Upon the execution of code, user programmable actions 335 are performed on data and/or containers in the system. As depicted, all data objects of “Invoice type” 325, 330 in a container “Current Invoices” 320 have their Date Created compared to the new Today's Date. Both of these date variables have been set by accessing the system clock and the file properties. If the difference between the dates is greater than 30 days, the Invoice data object is moved to a container “Past Due Invoices” 340. Invoice A 325 with a Date Created of Jul. 1, 2015 is within 30 days of Today's Date, Jul. 15, 2015. Invoice B 330 with a Date Created of Jun. 14, 2015 is no longer within 30 days of Today's Date, Jul. 15, 2015. The system moves 335 Invoice B 330 to the container “Past Due Invoices” 340. This can be performed by calling the system's move/copy file commands.

Triggers may be pre-programmed into a system as default specifications; alternatively, triggers can be programmed by end users. Containers can additionally have access permissions, security, and controls, which may be manually set or controlled by triggers and their associated behaviors.

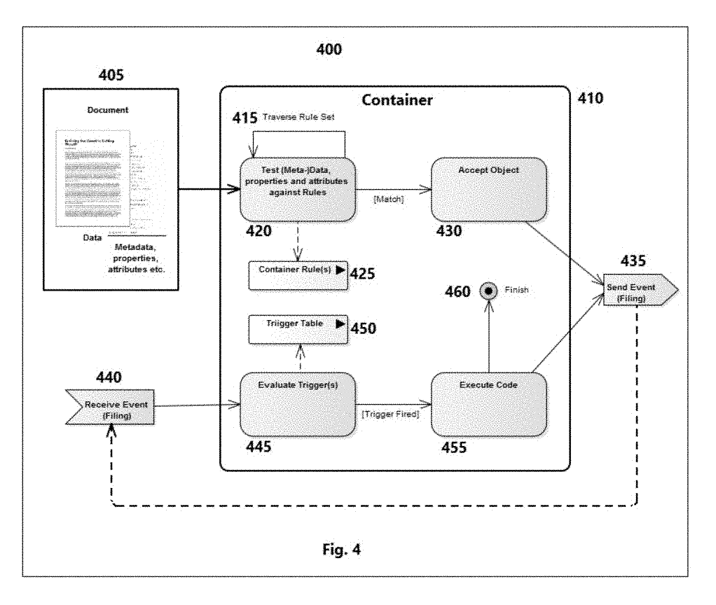

In some embodiments, triggers may be applied to a system that files and organizes data according to rules. When programmable behaviors and filing according to rules are used in combination, a fully automated system files and manages data for a user. As illustrated in FIG. 4, a flowchart 400 of the addition of an object to a container according to rules and the activation of a trigger is provided.

A new data item 405 is added to the system. The data item is recognized and analyzed as the system attempts to place it in an appropriate container 410. The container rule set is examined 415 and the data item metadata, properties and/or attributes are tested 420 against the container rules 425. If the data item matches, the item is accepted and added to the container 430. On filing in the container, a filing event 435 occurs. Upon the filing event recognition 440, triggers are evaluated 445 from the trigger table 450 associated with the container. If a trigger is activated then its corresponding code executes 455 and process concludes 460.

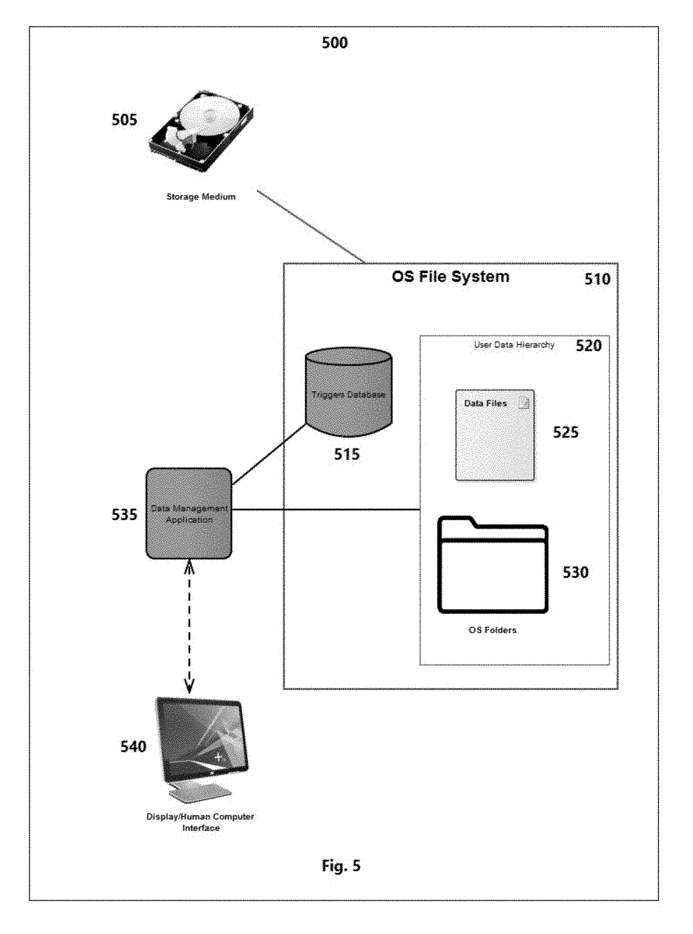

As illustrated in FIG. 5, a block diagram 500 of a general system embodiment on a single computer device is provided.

In a general system embodiment, a single computer device is configured to perform all elements of the invention. Some components of the computer include one or more processing units, storage medium 505 (hard disk, random access memory, cache memory, etc.), an OS, and an electronic visual display 540. All data is stored in OS file system folders, and the user interact with the User File Hierarchy 520 through the OS file manager. Triggers and behaviors can be implemented, at the most basic level, by loading a Data Management Application 535 TSR program in memory, running in the background and monitoring changes in the OS file system 510. Such a Data Management Application 535 would provide an interface for the user to add triggers and allow the user to connect the triggers to new or existing OS folders 530 on disk or external events. Triggers would be stored in a Trigger Database 515, along with the trigger's associated program code/behavior. The system is constantly monitored for changes to the folders 530 and files 525 and outside events which could cause a trigger to activate. Upon the recognition of an event, the trigger's associated program code is retrieved from the database 515 and executed (as object code, scripts, or even system commands). The Data Management Application can additionally alert the user if a trigger has been actuated causing a change to the system and which containers or files have been affected. Additionally, the performance of any trigger may require approval of the user.

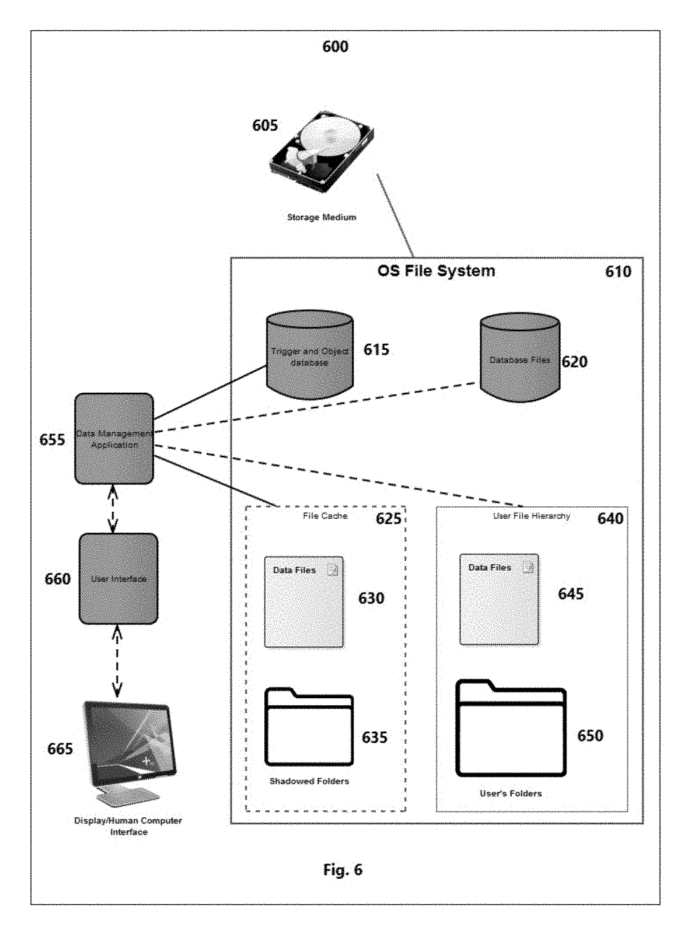

As illustrated in FIG. 6, a block diagram 600 of an alternative system embodiment on a single computer device is provided.

In an alternative system embodiment, a single computer device is configured to perform all elements of the invention. Some components of the computer include one or more processing units, storage medium 605 (hard disk, random access memory, cache memory, etc.), an OS, and an electronic visual display 665. A Data Management Application 655 can be loaded onto a computer, intermediating between the host OS file system 610 and its data files 645 and folders 650 as well as any database files 620. The Data Management Application 655 provides programmable containers into which the user may import data from available sources. Files are imported and information (enhanced metadata) extracted from the content and coupled to the OS metadata info. This information is attached to the file's record (a data object) in the Triggers and Object Database 615. The data files 630 and shadowed folders 635 may additionally be stored on disk in a file cache 625, not easily accessible to the user and protected by file permissions from deletion or moving except via the app's interface. The enhanced containers are only accessible through the User Interface 660 of the Data Management Application 655. These containers are virtual inasmuch as there may not be a physical folder on disk, although there could be, but all filing is done against virtual containers. Such a Data Management Application 655 would also provide an interface for the user to add triggers and allow the user to connect the triggers to new or existing containers or external events. Triggers would be stored in a Triggers and Object Database 615, along with the trigger's associated program code/behavior. The system is constantly monitored for changes to containers and data objects or events which could cause a trigger to be activated. Upon the recognition of an event, the trigger's associated program code is retrieved from the database 615 and executed. The Data Management Application can additionally alert the user if a trigger has been actuated causing a change to the system and which containers or files have been affected. Additionally, the performance of the trigger may require approval of the user.

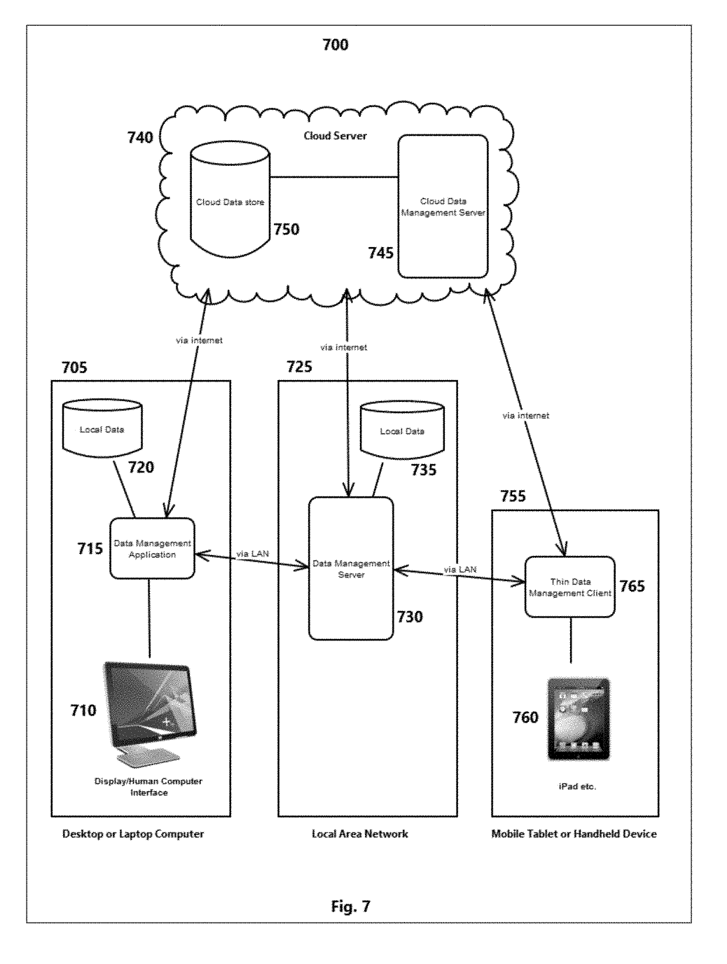

As illustrated in FIG. 7, a block diagram 700 of a general system embodiment on multiple computer devices is provided.

Either of the single computer embodiments can be modified to embodiments where the invention is performed over multiple computer devices in a client server configuration. As depicted, the user can interact with the system via a computer device 705. Some components of the computer include one or more processing units, storage medium (hard disk, random access memory, cache memory, etc.), an OS, and an electronic visual display 710. The computer device can be configured to run the Data Management Application 715 to create, manage and visualize the data as domains and member data objects. The data can be located directly on the computer device (local data 720) or can be accessed on a local area network server 725 or a cloud server 740 via the internet. The local area network server device 725 is configured with a Data Management server application 730 allowing for access to its own local data 735, as well as communication with the cloud server 740. The cloud server 740 is configured with a Data Management server application 745 allowing for access to it's the cloud data store 750, as well as communication with the client device 705 and local area network server 725 via the internee. The Data Management Application 715 is able to manage and synchronize local data 720 along with server data 735, 750 via the various data management applications. Further, a mobile device client 755, also with a visual display 760, can be configured with a thin Data. Management Application 765 that can only access data on local area network server 725 or a cloud server 740. It should be appreciated that other computer system configurations can be used.

The preceding description is of various embodiments and no limitation of the scope is thereby intended.

That which is claimed is:

1. A computer-implemented method comprising:
recognizing an event in a system;
identifying if the event matches a trigger in the trigger table and retrieving the behavior associated with the matching trigger;
performing the behavior associated with the trigger.

2. The method of claim 1, wherein the event occurs to a container or an object in a container.

3. The method of claim 2, wherein the event occurs on the addition of a new object to the container.

4. The method of claim 1, wherein the event is a system wide event.

5. The method of claim 1 wherein the executed behavior can initiate another event.

6. A data management system comprising:
at least one processor and memory;
a means for monitoring and recognizing an event in the system;
a database for storing triggers and their associated program code;
a means for identifying if the event matches a trigger in the database and retrieving the program code associated with the matching trigger;
a means for executing the program code associated with the trigger.

7. The system of claim 6, wherein the event occurs to a container or an object in a container.

8. The system of claim 7, wherein the event occurs on the addition of a new object to the container.

9. The system of claim 6, wherein the event is a system wide event.

10. The system of claim 6, wherein the executed program code can initiate another event.

11. An apparatus comprising at least one processor, the at least one processor configured to at least perform:
recognizing an event in a system;
identifying if the event matches a trigger in the trigger table and retrieving the behavior associated with the matching trigger;
performing the behavior associated with the trigger.

12. The apparatus of claim 11, wherein the event occurs to a container or an object in a container.

13. The apparatus of claim 12, wherein the event occurs on the addition of a new object to the container.

14. The apparatus of claim 11, wherein the event is a system wide event.

15. The apparatus of claim 11, wherein the executed behavior can initiate another event.
